(19) United States
(12) Patent Application Publication
(10) Pub. No.: US 2010/0120879 A1
(43) Pub. Date: May 13, 2010

(54) INSECTICIDES AS SAFENER FOR FUNGICIDES WITH PHYTOTOXIC ACTION

(75) Inventors: Jan Willem Burgers, Neustadt (DE); Dirk Voeste, Limburgerhof (DE); Edson Begliomini, Sao Paulo (BR); Alexander Guttenkunst Prade, Sao Bernardo Do Campo (BR)

Correspondence Address: BIRCH STEWART KOLASCH & BIRCH, PO BOX 747, FALLS CHURCH, VA, 22040-0747, US

(73) Assignee: BASF SE, Ludwigshafen (DE)

(21) Appl. No.: 12/524,614

(22) PCT Filed: Feb. 5, 2008
(86) PCT No.: PCT/EP2008/051393

§ 371 Date: Jul. 27, 2009

Related U.S. Application Data
(60) Provisional application No. 60/908,479, filed on Mar. 28, 2007.

(30) Foreign Application Priority Data
Feb. 6, 2007 (EP) 07101846.9

(51) Int. Cl. A01N 43/64; A01N 43/56; A01N 43/26

(52) U.S. Cl. 514/383; 514/404; 514/463; 514/406

(57) ABSTRACT

The present invention relates to the use of insecticides which are selected among GABA antagonists and nicotin receptor agonists/antagonists, if appropriate in combination with at least one gibberellin, as safener for fungicides which have a phytotoxic effect. Moreover, the invention relates to a method of reducing or preventing the phytotoxic effect of fungicides on plants treated therewith or on plants whose seeds or growth substrate have been or are treated with these fungicides. The invention finally also relates to compositions which comprise at least one GABA antagonist, at least one azole fungicide or strobilurin fungicide and, if appropriate, at least one gibberellin, and to compositions which comprise at least one nicotin receptor agonist/antagonist, at least one azole fungicide or strobilurin fungicide and, if appropriate, at least one gibberellin.

The present invention relates to the use of insecticides which are selected from among GABA antagonists and nicotin receptor agonists/antagonists, if appropriate in combination with at least one gibberellin, as safener for fungicides which have a phytotoxic effect. Moreover, the invention relates to a method of reducing or preventing the phytotoxic effect of fungicides on plants treated therewith or on plants whose seeds or growth substrate have been or are, treated with these fungicides. Finally, the invention also relates to compositions which comprise at least one GABA antagonist, at least one azole fungicide or strobilurin fungicide and, if appropriate, at least one gibberellin, and to compositions which comprise at least one nicotin receptor agonists/antagonists, at least one azole fungicide or strobilurin fungicide and, if appropriate, at least one gibberellin.

It is known that some plant protectants may have a phytotoxic effect on crop plants treated therewith. Thus, F. Montfort et al., Pesticide Science 46(4), 1996, 315-322, report that the use of azole fungicides, such as triticonazole, for the treatment of seed and crop plants may have an adverse effect on plant growth. For example, a greatly reduced longitudinal growth is observed when wheat is treated with fluquinconazole or triticonazole.

Experiments carried out by the applicant have demonstrated that other phytotoxic effects too occur in plants which have been treated with certain fungicides (mainly azole fungicides and also strobilurin fungicides), for example reduced or delayed germination or diminished emergence.

These disadvantageous effects, which are accompanied by yield losses and which, to some extent, ruin the fungicidal activity of these compounds, limit the economical benefit of using the fungicide.

It is therefore an object of the present invention to provide compounds which reduce or prevent the negative effects of phytotoxically active fungicides.

Surprisingly, it has been found that certain insecticides prevent, or at least reduce, the phytotoxic effects of such fungicides.

The object was achieved by the use of insecticides which are selected among GABA antagonists and nicotin receptor agonists/antagonists, if appropriate in combination with at least one gibberellin, as safener for fungicides which have a phytotoxic effect on plants treated therewith, seeds treated therewith or on plants which grow in a substrate treated therewith.

As a rule, the term “safener” is used for substances which reduce or prevent the damage to crop plants as the result of herbicides which are employed for destroying weeds. For the purposes of the present invention, however, this term is defined in more general terms and refers to substances which reduce or prevent the phytotoxic effect of crop protectants, in the present context specifically fungicides, on plants treated therewith and/or on plants whose seeds and/or growth substrate have been treated or are treated therewith. Thus, the subject matter of the present invention relates to the use of the above-named insecticides and, if appropriate, at least one gibberellin for reducing or preventing the phytotoxic effect of fungicides on plants which, and/or whose seeds, and/or whose growth substrates have been treated, or are treated, with these fungicides.

Naturally, the term “whose seeds” relates to the seed from which the plant has been grown and not the seed which it produces itself.

The term “seed” represents all types of plant propagation material. It comprises seeds in the actual sense, grains, fruits, tubers, the rhizome, spores, cuttings, slips, meristem tissue, individual plant cells and any form of plant tissue from which a complete plant can be grown. Preferably, it takes the form of seed in the actual sense.

“Growth substrate” refers to any type of substrate in which the plant grows or will grow, such as soil (for example in a pot, in borders or in the field) or artificial media. As a rule, it takes the form of the soil.

In one embodiment of the invention, the insecticides are selected among GABA antagonists.

The GABA antagonists are preferably selected among acetoprole, endosulfan, ethiprole, fipronil, vaniliprole, pyrafluprole, pyriprole and the phenylpyrazole compound of the formula Γ¹

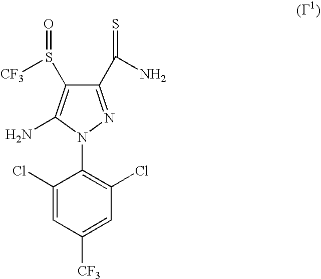

Fipronil is especially preferred as GABA antagonist.

In another embodiment of the invention, the insecticides are selected among nicotin receptor agonists/antagonists.

The nicotin receptor agonists/antagonists are preferably selected among acetamiprid, clothianidin, dinotefuran, imidacloprid, nitenpyram, thiacloprid and thiamethoxam.

They are especially preferably selected among acetamiprid, clothianidin, imidacloprid and thiamethoxam, more preferably among clothianidin, imidacloprid and thiamethoxam and even more preferably among clothianidin and imidacloprid. Specifically, the nicotin receptor agonist/antagonist is clothianidin.

Insecticides from the group of the GABA antagonists and nicotinyl receptor agonists/antagonists and processes for their preparation are known. They are described, for example, in The Pesticide Manual, 13th edition, British Crop Protection Council (2003), in Farm Chemicals Handbook, volume 88, Meister Publishing Company, 2001, and in http:\\www.hclrss.demon.co.uk/index.html, which are herewith referred to in their entirety.

The gibberellins are preferably selected among those of the formula I

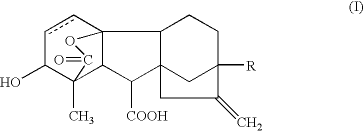

in which
R represents a hydrogen atom or a hydroxyl group; and ---- means that a single bond or a C—C double bond is present at this position.

The following four compounds of the formula I-1 to I-4 come under the compounds of the formula I:

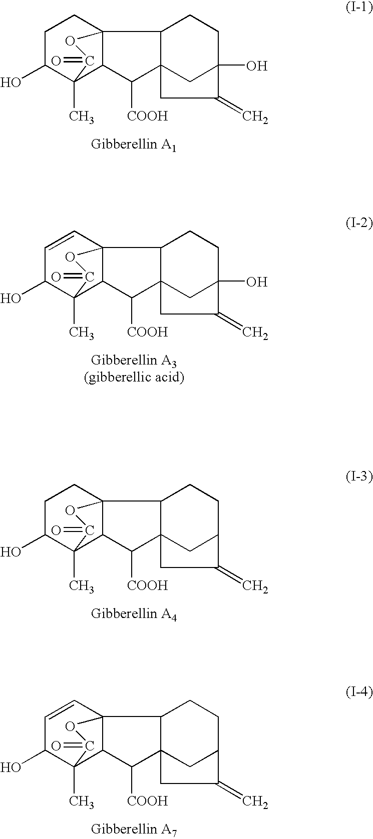

Gibberellins of the formula I and processes for their preparation are known and are described, for example, in WO 02/069715, hereby fully incorporated herein by reference.

The gibberellin is especially preferably gibberellic acid (gibberellin A₃), of the formula (I-2).

The phytotoxically active fungicides are preferably selected among azole fungicides and strobilurin fungicides.

Azole fungicides, also referred to as conazole fungicides, are fungicidally active compounds which comprise an aromatic 5-membered nitrogen heterocycle. In particular, they comprise an imidazole ring (“imidazole conazoles”) or a triazole ring (“triazole conazoles”).

Azole fungicides and processes for their preparation are, in principle, known to the skilled worker and described, for example, in Farm Chemicals Handbook, Meister Publishing Company or in the Compendium of Pesticide Common Names, http://www.hclrss.demon.co.uk/, which are herewith referred to in their entirety.

Preferred azole fungicides are those which are known by the common names bitertanol, bromoconazole, cyproconazole, difenoconazole, dinitroconazole, epoxiconazole, fenbuconazole, fluquinconazole, flusilazole, flutriafol, hexaconazole, imazalil, metconazole, myclobutanil, penconazole, prochloraz, propiconazole, prothioconazole, tebuconazole, triadimefon, triadimenol, triflumizole and triticonazole.

Especially preferred azole fungicides are selected among difenoconazole, epoxiconazole, fluquinconazole, flutriafol, imazalil, metconazole, prochloraz, propiconazole, prothioconazole, tebuconazole, triadimenol and triticonazole. More preferred are the azole fungicides selected among epoxiconazole, fluquinconazole, flutriafol, prochloraz, prothioconazole, tebuconazole and triticonazole and even more preferred among epoxiconazole, fluquinconazole, prochloraz and triticonazole. In particular, they are selected among fluquinconazole, prochloraz and triticonazole. Specifically, they are selected among prochloraz and triticonazole. Even more specifically, the azole fungicide is triticonazole.

Strobilurin fungicides are fungicidally active compounds which are derived from natural strobilurins, defense substances produced by fungi of the genus Strobilurus (Strobilurus species). Structurally, they comprise 1.) at least one functional group which is selected among enol ethers, oxime ethers and O-alkylhydroxylamines (group I) and 2.) at least one carboxyl derivative (group II). Preferred carboxyl derivatives are the following functional group: ester, cyclic ester, amide, cyclic amide, hydroxamic acid and cyclic hydroxamic acid. Preferably, the radicals of group I and group II are directly adjacent, i.e. linked by a single bond.

Strobilurin fungicides are known to the skilled worker in principle and described, for example, in Farm Chemicals Handbook, Meister Publishing Company or in the Compendium of Pesticide Common Names, http://www.hclrss.demon.co.uk/, which are herewith referred to in their entirety.

Especially preferred strobilurins are those which are known by the common names azoxystrobin, dimoxystrobin, fluoxastrobin, kresoxim-methyl, methaminostrobin, orysastrobin, picoxystrobin, pyraclostrobin and trifloxystrobin. More preferably, the strobilurin fungicides are selected among pyraclostrobin, azoxystrobin, orysastrobin and dimoxystrobin. Even more preferably, the strobilurin fungicides are selected among azoxystrobin, orysastrobin and dimoxystrobin and, in particular, dimoxystrobin.

The above-described fungicides, insecticides and gibberellins can also be employed in the form of their agriculturally tolerated salts. Thus, all compounds which comprise basic nitrogen atoms in the molecule (as is the case for example with all azole fungicides, with azoxystrobin, fluoxastrobin, pyraclostrobin, with acetamiprid, clothianidin, imidacloprid, nitenpyram, thiacloprid, thiamethoxam, acetoprole, ethiprole, fipronil, vaniliprole, pyrafluprole, pyriprole and the compound of the formula Γ¹) can be employed in the form of their acid addition salts. Compounds with abstractable protons (for example with carboxyl groups, such as the gibberellin I) can be employed in the form of their salts with metal cations, ammonium ions, phosphonium ions, sulfonium ions or sulfoxonium ions.

The acid addition salts can be prepared for example by reacting the free bases with a suitable Brönsted acid. Suitable acids have agriculturally tolerated acid anions and are selected for example among hydrohalic acids such as hydrofluoric acid, hydrochloric acid, hydrobromic acid, and hydriodic acid, sulfuric acid, phosphoric acid, nitric acid, benzoic acid and C₁-C₄-alkanoic acids such as formic acid, acetic acid, propionic acid and butyric acid.

Examples of suitable cations are, in particular, the cations of the alkali metals, preferably lithium, sodium or potassium, of the alkaline earth metals, preferably calcium, magnesium or barium, and of the transition metals, preferably manganese, copper, zinc or iron. Suitable ammonium cations are the ammonium cation itself (NH₄⁺) and also substituted ammonium ions in which 1 to 4 of the hydrogen atoms are replaced by C₁-C₄-alkyl, C₁-C₄-hydroxyalkyl, C₁-C₄-alkoxy, C₁-C₄-alkoxy-C₁-C₄-alkyl, hydroxy-C₁-C₄-alkoxy-C₁-C₄-alkyl, phenyl or benzyl. Examples of suitable ammonium ions comprise methylammonium, ethylammonium, propylammonium, isopropylammonium, butylammonium, dimethylammonium, diethylammonium, dipropylammonium, diisopropylammonium, dibutylammonium, trimethylammonium, triethylammonium, tripropylammonium, tributylammonium, tetramethylammonium, tetraethylammonium, tetrapropylammonium, tetrabutylammonium, 2-hydroxyethyl-ammonium, 2-(2-hydroxyethoxy)ethylammonium, bis(2-hydroxyethyl)ammonium, benzyltrimethylammonium and benzyltriethylammonium. Also suitable are phosphonium ions, sulfonium ions such as tri(C₁-C₄-alkyl)sulfonium, and sulfoxonium ions, such as tri(C₁-C₄-alkyl)sulfoxonium.

C₁-C₄-Alkyl represents methyl, ethyl, n-propyl, isopropyl, n-butyl, sec-butyl, isobutyl or tert-butyl.

C₁-C₄-Hydroxyalkyl represents a C₁-C₄-alkyl radical in which at least one hydrogen atom is replaced by a hydroxyl group. Examples are hydroxymethyl, 1- and 2-hydroxyethyl, 1,2-dihydroxyethyl, 1-, 2- and 3-hydroxypropyl, 1,2-dihydroxypropyl, 1,3-dihydroxypropyl, 2,3-dihydroxypropyl, 1,2,3-trihydroxypropyl, 1-, 2-, 3- and 4-hydroxybutyl and the like.

C₁-C₄-Alkoxy represents a C₁-C₄-alkyl radical which is bonded via an oxygen atom. Examples are methoxy, ethoxy, propoxy, isopropoxy, n-butoxy, sec-butoxy, isobutoxy and tert-butoxy.

C₁-C₄-Alkoxy-C₁-C₄-alkyl represents a C₁-C₄-alkyl radical in which at least one hydrogen atom is replaced by an alkoxy group. Examples are methoxymethyl, ethoxymethyl, propoxymethyl, isopropoxymethyl, butoxymethyl, sec-butoxymethyl, isobutoxymethyl, tert-butoxymethyl, methoxyethyl, 1- and 2-ethoxyethyl, 1- and 2-propoxyethyl, 1- and 2-isopropoxyethyl, 1- and 2-butoxyethyl, 1- and 2-sec-butoxy-ethyl, 1- and 2-isobutoxyethyl, 1- and 2-tert-butoxyethyl, 1-, 2- and 3-methoxypropyl, 1-, 2- and 3-ethoxypropyl, 1-, 2- and 3-propoxypropyl, 1-, 2- and 3-isopropoxypropyl, 1-, 1-, 2- and 3-butoxypropyl, 1-, 2- and 3-sec-butoxypropyl, 1-, 2- and 3-isobutoxypropyl, 1-, 1-, 2- and 3-tert-butoxypropyl and the like.

Hydroxy-C₁-C₄-alkoxy-C₁-C₄-alkyl represents a C₁-C₄-alkyl radical, in which at least one hydrogen atom is replaced by at least one alkoxy group. In addition, at least one hydrogen atom in the alkyl radical or in the alkoxy radical or in both is replaced by a hydroxyl group. Examples are (2-hydroxyethoxy)methyl, (2- and 3-hydroxypropoxy)-methyl, (2-hydroxyethoxy)ethyl, (2- and 3-hydroxypropoxy)-1-ethyl, (2- and 3-hydroxy-propoxy)-2-ethyl, 2-ethoxy-1-hydroxyethyl and the like.

Gibberellins which comprise a carboxyl group in the molecule, such as, for example, the gibberellins of the formula I, may be employed not only in the form of their salts, but also in ester form. Suitable esters are in particular those with C₁-C₄-alkanols such as methanol, ethanol, propanol, isopropanol, n-butanol, sec-butanol, isobutanol and tert-butanol.

The use according to the invention of safeners reduces or prevents the phytotoxic effect which certain fungicides exert on the plants or seeds treated therewith or on plants which are grown from seeds treated therewith or which grow in a growth substrate treated therewith.

“Treatment of the plant” means that the plant, or, to be more precise, aerial plant parts, is treated during the life of the plant, i.e. between emergence and dying down or harvesting, preferably during the vegetative phase, i.e. from emergence until before anthesis.

The phytotoxic effect which these fungicides have can manifest itself in various ways and can be recognized by comparing plants which and/or whose seeds and/or whose growth substrate have been treated with a phytotoxically active fungicide and plants which, whose seeds and whose growth substrate have not been treated with this fungicide. Naturally, the comparison must be carried out under pathogen-free conditions since otherwise the untreated plants might, as the result of infection, display symptoms which correspond to the phytotoxic effects or are similar thereto.

The phytotoxic effect manifests itself for example in that seeds which have been treated with the fungicide in question and/or which are sown in a fungicide-treated growth substrate germinate more poorly. Poorer germination means that the same number of seeds gives rise to fewer seedlings in comparison with seeds which have not been treated with the fungicide in question and which grow in a correspondingly untreated growth substrate.

Alternatively, or additionally, the phytotoxic effect may manifest itself in reduced emergence. “Emergence”, also referred to as “emergent”, is understood as meaning that the seedling appears from the soil. Reduced emergence means that fewer seedlings appear from the soil from the same number of seeds in comparison with seeds which have not been treated with the fungicide in question and which germinate and grow in a growth substrate which has not been treated correspondingly.

In some plant species, germination and emergence may coincide, i.e. the first cotyledon already appears from the soil. However, since this is not the case with all plants, germination and emergence are described separately.

Alternatively or in addition, the phytotoxic effect can manifest itself in reduced growth of the hypocotyl, i.e. the stalk does not grow as long as expected, and, possibly, leaves and apex lie on the ground. In some plants, such as cereals, this characteristic is not necessarily disadvantageous since it reduces or prevents lodging; in some plant species, however, it is entirely undesirable.

Alternatively or in addition, the phytotoxic effect of the fungicide may manifest itself in diminished vitality of the plants. Diminished vitality can be ascertained by comparison with plants which, whose seeds and whose growth substrate have not been treated with the phytotoxic fungicide in question. The vitality of a plant manifests itself in a variety of factors. Examples of factors which are manifestations of the plant's vitality are:
(a) overall visual appearance;
(b) root growth and/or root development;
(c) size of the leaf area;
(d) intensity of the leaves' green coloration;
(e) number of dead leaves in the vicinity of the ground;
(f) plant height;
(g) plant weight;
(h) growth rate;
(i) appearance and/or number of fruits;
(j) plant stand density;
(k) germination behavior;
(l) emergence behavior;
(m) shoot number;
(n) shoot type (quality and productivity)
(o) toughness of the plant, for example resistance to biotic or abiotic stress;
(p) presence of necroses;
(q) senescence behavior.

Accordingly, the phytotoxic effect can manifest itself in a worsening of at least one of the abovementioned factors, for example in
(a) a poorer overall visual appearance;
(b) poorer root growth and/or poorer root development;
(c) reduced size of the leaf area;
(d) less intense green coloration of the leaves;
(e) more dead leaves in the vicinity of the ground;
(f) lower plant height;
(g) lower plant weight;
(h) poorer growth rate;
(i) poorer appearance and/or lower number of fruits;
(j) lower plant stand density;
(k) poorer germination behavior (see hereinabove);
(l) poorer emergence behavior (see hereinabove);
(m) fewer shoots;
(n) shoots in lower quality (for example weak shoots), less productive shoots
(o) reduced toughness of the plant, for example reduced resistance to biotic or abiotic stress;
(p) presence of necroses;
(q) a poorer senescence behavior (earlier senescence).

Biotic stress is caused by organisms, for example by pests (such as insects, arachnids, nematodes and the like), competing plants (for example weeds), phytopathogenic fungi and other microorganisms such as bacteria and viruses. Abiotic stress is triggered for example by extreme temperatures such as heat, chill, great variations in temperature, or unseasonal temperatures, drought, extreme wetness, high salinity, radiation (for example increased UV radiation as the result of the diminishing ozone layer), increased amount of ozone in the vicinity of the soil and/or organic and inorganic pollution (for example as the result of phytotoxic amounts of pesticides or contamination with heavy metals). Biotic and abiotic stress leads to a reduced quantity and/or quality of the stressed plant and its fruits. Thus, for example, the synthesis and addition of proteins is mainly adversely affected by temperature stress, while growth and polysaccharide synthesis are reduced by virtually all stress factors. This leads to biomass losses and to a reduced nutrient content of the plant product.

It is clear that the appearance of the individual symptoms of the phytotoxic effect depends on whether the plant itself (or aerial parts thereof), its seed or its growth substrate have been treated with the fungicide. Thus, poorer germination behavior will naturally only be observed when the seed and/or the growth substrate have been treated before or shortly after sowing. The same applies to the emergence behavior. Reduced plant vitality (e.g. in the form of a deterioration of at least one of the features (a) to (j) and (m) to (q)), however, can also be observed when the plant or parts thereof have been treated during the life of the plant (i.e. between emergence and harvest or dying down).

However, the phytotoxic effects can be observed mainly when the seed from which the plant has been grown and/or the plant's growth substrate have been treated with the fungicides in question—especially before emergence of the plant—and in particular when the seed has been treated with the fungicide in question.

In a preferred embodiment, the invention relates to the use of the above-described insecticides and, if appropriate, the above-described gibberellins for improving the germination of plants whose seeds and/or growth substrate have been treated, or are treated, with a fungicide as defined hereinabove.

In a further preferred embodiment, the invention relates to the use of the above-described insecticides, if appropriate in combination with the above-described gibberellins, for improving the emergence of plants which and/or whose seeds and/or whose growth substrate have been treated, or are treated, with a fungicide as defined hereinabove.

In a further preferred embodiment, the invention relates to the use of the above-described insecticides, if appropriate in combination with the above-described gibberellins, for improving the vitality of plants which and/or whose seeds and/or whose growth substrate have been treated, or are treated, with a fungicide as defined hereinabove.

In particular, the invention relates to the use of at least one of the abovementioned insecticides, if appropriate in combination with the above-described gibberellins, for improving the germination and/or the emergence and/or the vitality of plants whose seeds have been treated with a fungicide as defined hereinabove.

In principle, the plants can take the form of all plant species and plant varieties which are usually treated with the above-described fungicides and where a phytotoxic effect is observed as the result of this treatment. As a rule, these plants are agriculturally useful plants or else ornamentals. Agriculturally useful plants are crop plants where parts or the entire plant act as a raw material for foodstuffs, feeding stuffs, fibers (for example cotton, linen), fuels (for example timber, bioethanol, biodiesel, biomass) or other chemical compounds. Examples are soybean, maize, wheat, triticale, rye, oats, barley, oilseed rape, millet/sorghum, rice, sunflower, cotton, sugar beet, stone fruit, pome fruit, citrus fruit, banana, strawberry, blueberry, almond, grape, mango, pawpaw, peanut, potato, tomato, capsicum, cucumber, pumpkin/squash, melon, watermelon, garlic, onion, carrot, cabbage, bean, vegetable pea and fodder pea, lentil, lucerne, clover, flax, elephant grass (Miscanthus), grass, lettuce, sugar cane, tea, tobacco and coffee.

Preferred agriculturally useful plants are selected from among soybean, maize, wheat, triticale, oats, rye, barley, oilseed rape, millet/sorghum, rice, sunflower and sugar cane, more preferably among soybean, wheat, maize, rice and oilseed rape and even more preferably among soybean and wheat. Particularly preferably, it is soybean.

Alternatively, preferred agriculturally useful plants are selected among potato, tomato, capsicum, cucumber, pumpkin/squash, melon, watermelon, garlic, onion, carrot, cabbage, bean, vegetable pea, fodder pea and lettuce, more preferably among tomato, onion, lettuce and pea.

Examples of ornamentals are turf, geranium, pelargonium, petunia, begonia and fuchsia, to mention only a few examples of a large number of ornamentals.

The plants can be non-transgenic or transgenic in nature.

In one embodiment of the invention, it is preferred that the recombinant modification of the transgenic plant is such in nature that the plant has resistance to a certain plant protection agent, e.g. a herbicide. For example, the transgenic plant can have a resistance to the herbicide glyphosate. Examples of transgenic plants are those with a resistance to herbicides from the group of the sulfonylurea (see, for example, EP-A-0257993, U.S. Pat. No. 5,013,659), the imidazolinones (see, for example, U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073), of the glufosinate type (see, for example, EP-A-0242236, EP-A-242246) or of the glyphosate type (see, for example, WO 92/00377) or plants with resistance to herbicides from the group of the cyclohexadienones/aryloxyphenoxypropionic acid herbicides (see, for example, U.S. Pat. No. 5,162,602, U.S. Pat. No. 5,290,696, U.S. Pat. No. 5,498,544, U.S. Pat. No. 5,428,001, U.S. Pat. No. 6,069,298, U.S. Pat. No. 6,268,550, U.S. Pat. No. 6,146,867, U.S. Pat. No. 6,222,099, U.S. Pat. No. 6,414,222) or transgenic plants such as cotton which are capable of forming Bacillus thuringiensis toxins (Bt toxins) which may make them resistant to certain pests (see, for example, EP-A-0142924, EP-A-0193259).

An example of a transgenic plant are transgenic soybean plants with herbicide resistance, in particular with glyphosate resistance (Roundup Ready resistance).

As regards the manner and the amount in which the above-described fungicides, insecticides and gibberellins are employed, reference is made to what is said hereinbelow in connection with the method according to the invention.

The present invention furthermore relates to a method of reducing or preventing the phytotoxic effect of fungicides on plants which and/or whose seeds and/or whose growth substrates have been or are treated with these fungicides, where the plant and/or its seed and/or its growth substrate is treated with at least one of these fungicides in combination with at least one of the above-described insecticides and, if appropriate, with at least one of the above-described gibberellins.

As regards suitable and preferred fungicides, insecticides, gibberellins and plants, reference is made to what has been said above.

The method is preferably used for reducing or preventing the phytotoxic effect of fungicides as defined above on plants, whose seeds have been treated with this fungicide, where the seeds of the plant are treated with at least one of these fungicides in combination with at least one of the above-described insecticides and, if appropriate, with at least one of the above-described gibberellins.

The method is preferably used for improving the germination and/or the emergence and/or the vitality of the plant treated thus.

The treatment of the plants, its seed and/or its growth substrate can be accomplished for example in such a way that the plant, a part thereof, its seed and/or its growth substrate is treated with a mixture of the at least one fungicide, the at least one insecticide and, if appropriate, the at most one gibberellin. Alternatively, the plant, its seed and/or its growth substrate can be treated with the at least one fungicide, the at least one insecticide and, if appropriate, the at least one gibberellin in separate form, it being possible for the treatment with the individual active substances to be accomplished simultaneously or in succession. In the case of successive treatment, the time interval may be from a few seconds up to several months, for example up to 6, 8 or even 10 months. However, the time interval must be such that the desired effect can take place. Preferably, the interval between the treatments is relatively short, i.e. fungicide, insecticide and, if appropriate, gibberellin are applied within a time interval of from a few seconds up to at most one month, especially preferably up to not more than one week and in particular up to not more than one day. In principle, it is possible to apply the different active substances to different subjects (subjects being, in the present context, plant, seed and growth substrate), that is, for example, to treat the seed with one of the active substances, for example with the fungicide, and to apply the other active substance(s), for example the insecticide and, if appropriate, the gibberellin, to the plant which develops from the seed and/or to treat their growth substrate therewith. However, it is preferred to apply all active substances employed to the same subject. In the case of the successive treatment, the sequence in which the individual active substances are applied is, as a rule, as desired. Frequently, however, the at least one fungicide is applied first, followed by the at least one insecticide and, if appropriate, by the at least one gibberellin.

It is especially preferred to treat the seed and/or the growth substrate, and in particular the seed. Here, the seed may be treated before sowing or else via the growth substrate into which it is sown, for example during sowing in the form of what is known as the in-furrow application. In this form of application, the plant protectant is placed into the furrow essentially at the same time as the seed.

The ratio of the total weight of fungicide(s) employed according to the invention to the total weight of insecticide(s) employed in accordance with the invention is preferably 100:1 to 1:100, especially preferably 50:1 to 1:50, more preferably 10:1 to 1:10, even more preferably 5:1 to 1:5 and in particular 1.5:1 to 1:5, e.g. 1.2:1 to 1:3 or 1:1 to 1:2.

If a gibberellin is used, then the ratio of the total weight of fungicide(s) employed in accordance with the invention to the total weight of gibberellin(s) employed in accordance with the invention is preferably 200:1 to 1:1, especially preferably 100:1 to 1:1, more preferably 100:1 to 2:1, even more preferably 70:1 to 5:1 and in particular 70:1 to 10:1.

The active substances (i.e. the at least one fungicide, the at least one insecticide and the at least one gibberellin which is employed, if appropriate) can be formulated, in the ready-to-use preparations, in suspended, emulsified or dissolved form, either jointly or separately. The use forms depend entirely on the intended purposes.

The active substances can be employed as such, in the form of their formulations or the use forms prepared therefrom, for example in the form of directly sprayable solutions, powders, suspensions or dispersions, also highly concentrated aqueous, oily or other suspensions or dispersions, emulsions, oil dispersions, pastes, dusts, tracking powders or granules. The application is usually accomplished by spraying, misting, atomizing, scattering or pouring. The use forms and use methods depend on the intended purposes; in any case, they should ensure the finest possible distribution of the active substances.

Depending on the presentation in which the ready-to-use preparations of the active substances are present, they comprise one or more liquid or solid carriers, optionally surface-active substances and optionally further adjuvants which are conventionally used for the formulation of plant protectants. The compositions for such formulations are well known to the skilled worker.

Aqueous use forms can be prepared for example starting from emulsion concentrates, suspensions, pastes, wettable powders or water-dispersible granules by adding water. To prepare emulsions, pastes or oil dispersions, the active substances, as such or dissolved in an oil or solvent, can be homogenized in water by means of wetter, adhesive, dispersant or emulsifier. However, it is also possible to prepare concentrates consisting of active substance, wetter, adhesive, dispersant or emulsifier and, if appropriate, solvent or oil, and such concentrates are suitable for dilution with water.

The concentrations of the active substances in the ready-to-use preparations can be varied within substantial ranges. In general, they are between 0.0001 and 10%, preferably between 0.01 and 1% (% by weight total active substance content based on the total weight of the ready-to-use preparation).

The active substances can also be employed successfully in the ultra-low-volume method (ULV), it being possible to apply formulations with more than 95% by weight of active substance, or indeed the active substances without additives.

It is possible to add, to the active substances, oils of various types, wetters, adjuvants, herbicides, fungicides and insecticides which are other than the active substances employed in accordance with the invention, nematicides, other pesticides such as bactericides, fertilizers and/or growth regulators which are other than the gibberellins employed in accordance with the invention, if appropriate only just before use (tank mix). These can be admixed to the active substances employed in accordance with the invention in a weight ratio of 1:100 to 100:1, preferably 1:10 to 10:1.

Adjuvants within this meaning are, in particular, organic modified polysiloxanes, for example Break Thru S 240®; alcohol alkoxylates, for example Atplus 245®, Atplus MBA 1303®, Plurafac LF 300® and Lutensol ON 30®; EO/PO block polymers, for example Pluronic RPE 2035® and Genapol B®; alcohol ethoxylates, for example Lutensol XP 80®; and sodium dioctyl sulfosuccinate, for example Leophen RA®.

When using the active substances employed in accordance with the invention jointly with other fungicides, a widening of the fungicidal spectrum of activity results in many cases.

The following list of fungicides together with which the active substances employed in accordance with the invention can be applied are intended to illustrate, but not to limit, the possible combinations:
acylalanines such as benalaxyl, metalaxyl, ofurace, oxadixyl;
amine derivatives such as aldimorph, dodine, dodemorph, fenpropimorph, fenpropidin, guazatine, iminoctadine, tridemorph;
anilinopyrimidines such as pyrimethanil, mepanipyrim or cyprodinil;
antibiotics such as cycloheximid, griseofulvin, kasugamycin, natamycin, polyoxine or streptomycin;
dicarboximides such as iprodion, myclozolin, procymidon, vinclozolin;
dithiocarbamates such as ferbam, nabam, maneb, mancozeb, metam, propineb, polycarbamate, thiram, ziram, zineb;
heterocyclic compounds such as anilazin, benomyl, carbendazim, dazomet, fenarimol, flutolanil, furametpyr, isoprothiolan, mepronil, nuarimol, probenazol, pyrifenox, pyroquilon, quinoxyfen, thiophanat-methyl, tricyclazol, triforine;
copper fungicides such as Bordeaux mixture, copper acetate, copper oxychloride, basic copper sulfate;
nitrophenyl derivatives such as binapacryl, dinocap, dinobuton, nitrophthal-isopropyl;
phenylpyrroles such as fenpiclonil or fludioxonil;
sulfur;
other fungicides such as carpropamide, chlorothalonil, cymoxanil, diclomezin, diclocymet, diethofencarb, edifenphos, fentin acetate, ferimzone, fluazinam, fosetyl, fosetyl-aluminum, hexachlorobenzene, pencycuron, phthalide, quintozene;
sulfenic acid derivatives such as captafol, captan, dichlofluanid, folpet;
cinnamamides and analogs such as dimethomorph, flumetover.

In a specific embodiment of the invention, no further fungicides are employed in addition to the fungicides employed in accordance with the invention.

The formulations are prepared in a known manner, e.g. by extending the active substance(s) with solvents and/or carriers, if desired using surface-active substances, i.e. emulsifiers and dispersants. Solvents/auxiliaries which are suitable are essentially:
water, aromatic solvents (for example Solvesso products, xylene), paraffins (for example mineral fractions), alcohols (for example methanol, butanol, pentanol, benzyl alcohol), ketones (for example cyclohexanone, methyl hydroxybutyl ketone, diacetone alcohol, mesityl oxide, isophorone), lactones (for example gamma-butyrolacton), pyrrolidones (pyrrolidone, N-methylpyrrolidone, N-ethylpyrrolidone, n-octylpyrrolidone), acetates (glycol diacetate), glycols, fatty acid dimethylamides, fatty acids and fatty acid esters. In principle, solvent mixtures may also be used.
carriers such as ground natural minerals (e.g. kaolins, clays, talc, chalk) and ground synthetic minerals (e.g. highly disperse silica, silicates); emulsifiers such as nonionic and anionic emulsifiers (e.g. polyoxyethylene fatty alcohol ethers, alkylsulfonates and arylsulfonates) and dispersants such as lignin-sulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalene-sulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, poly-oxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, mesityl oxide, isophorone, strongly polar solvents, for example dimethyl sulfoxide, 2-pyrrolidone, N-methylpyrrolidone, butyrolactone and water.

Powders, materials for spreading and dusts can be prepared by mixing or concomitantly grinding the active substances with a solid carrier.

Granules, for example coated granules, impregnated granules and homogeneous granules, can be prepared by binding the active ingredients to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

Formulations for the treatment of seed may additionally comprise binders and/or gelling agents and, if appropriate, colorants.

In general, the formulations comprise from 0.01 to 95% by weight, preferably from 0.1 to 90% by weight, in particular from 5 to 50% by weight, of the active substance. The active substances are employed in a purity of from 90% to 100%, preferably 95% to 100% (according to NMR spectrum).

For the treatment of seed, the relevant formulations will, after having been diluted by a factor of two to ten, give active substance concentrations of from 0.01 to 60% by weight, preferably 0.1 to 40% by weight, in the ready-to-use preparations.

The following are examples of formulations:

1. Products for dilution with water
I) Water-soluble concentrates (SL, LS)
10 parts by weight of active substance are dissolved in 90 parts by weight of water or a water-soluble solvent. As an alternative, wetters or other adjuvants are added. The active substance dissolves upon dilution with water. This gives a formulation with an active substance content of 10% by weight.
II) Dispersible concentrates (DC)
20 parts by weight of active substance are dissolved in 70 parts by weight of cyclohexanone with addition of 10 parts by weight of a dispersant, for example polyvinylpyrrolidone. The active substance content is 20% by weight. Dilution with water gives a dispersion.
III) Emulsifiable concentrate (EC)
15 parts by weight of active substance are dissolved in 75 parts by weight of xylene with addition of calcium dodecylbenzenesulfonate and castor oil ethoxylate (in each case 5 parts by weight). The formulation has an active substance content of 15% by weight. Dilution with water gives an emulsion.
IV) Emulsions (EW, EO, ES)
25 parts by weight of active substance are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier (Ultraturrax) and made into a homogeneous emulsion. The formulation has an active substance content of 25% by weight.
V) Suspensions (SC, OD, FS)
In an agitated ball mill, 20 parts by weight of active substance are comminuted with addition of 10 parts by weight of dispersants and wetters and 70 parts by weight of water or an organic solvent to give a fine active substance suspension. The active substance content in the formulation is 20% by weight. Dilution with water gives a stable suspension of the active substance.
VI) Water-dispersible granules and water-soluble granules (WG, SG)
50 parts by weight of active substance are ground finely with addition of 50 parts by weight of dispersants and wetters and made into water-dispersible or water-soluble granules by means of technical appliances (for example extrusion, spray tower, fluidized bed). The formulation has an active substance content of 50% by weight. Dilution with water gives a stable dispersion or solution of the active substance.
VII) Water-dispersible powders and water-soluble powders (WP, SP, SS, WS)
75 parts by weight of active substance are ground in a rotor-stator mill with addition of 25 parts by weight of dispersants, wetters and silica gel. The active substance content of the formulation is 75% by weight. Dilution with water gives a stable dispersion or solution of the active substance.
VIII) Gel formulations (GF)
In a ball mill, 20 parts by weight of active substance, 10 parts by weight of dispersant, 1 part by weight of gelling agent and 70 parts by weight of water or of an organic solvent are mixed to give a fine suspension.
   2. Products to be applied undiluted
IX) Dusts (DP, DS)
5 parts by weight of active substance are ground finely and mixed intimately with 95 parts by weight of finely divided kaolin. This gives a tracking powder with an active substance content of 5% by weight.
X) Granules (GR, FG, GG, MG)
0.5 parts by weight of active substance are ground finely and associated with 95.5 parts by weight of carriers. Current methods here are extrusion, spray-drying or the fluidized bed. This gives granules to be applied undiluted with an active substance content of 0.5% by weight.
XI) ULV solutions (UL)
10 parts by weight of active substance are dissolved in 90 parts by weight of an organic solvent, for example xylene. This gives a product to be applied undiluted with an active substance content of 10% by weight.

Suitable formulations for the treatment of seeds are, for example:

water-soluble concentrates (LS)
III emulsifiable concentrates (EC)
IV emulsions (ES)
V suspensions (FS)
VI water-dispersible granules and water-soluble granules (SG)
VII water-dispersible powders and water-soluble powders (WS, SS)
VIII gel formulations (GF)
IX dusts and dust-like powders (DS)

For the treatment of seed, it is preferred to use FS formulations. Usually, such formulations comprise from 1 to 800 g/l active substance, 1 to 200 g/l surfactants, 0 to 200 g/l antifreeze agent, 0 to 400 g/l binder, 0 to 200 g/l colorants and solvents, preferably water.

Preferred FS formulations of the active substances for the treatment of seed usually comprise 0.5 to 80% active substance, 0.05 to 5% wetter, 0.5 to 15% dispersant, 0.1 to 5% thickener, 5 to 20% antifreeze agent, 0.1 to 2% antifoam, 1 to 20% pigment and/or colorants, 0 to 15% adhesive or sticker, 0 to 75% filler/vehicle and 0.01 to 1% preservative.

Suitable pigments or colorants for formulations of the active substances for the treatment of seed are Pigment blue 15:4, Pigment blue 15:3, Pigment blue 15:2, Pigment blue 15:1, Pigment blue 80, Pigment yellow 1, Pigment yellow 13, Pigment red 112, Pigment red 48:2, Pigment red 48:1, Pigment red 57:1, Pigment red 53:1, Pigment orange 43, Pigment orange 34, Pigment orange 5, Pigment green 36, Pigment green 7, Pigment white 6, Pigment brown 25, Basic violet 10, Basic violet 49, Acid red 51, Acid red 52, Acid red 14, Acid blue 9, Acid yellow 23, Basic red 10, Basic red 108.

Wetters and dispersants which are suitable are, in particular the abovementioned surface-active substances. Preferred wetters are alkylnaphthalenesulfonates such as diisopropyl- or diisobutylnaphthalenesulfonates. Preferred dispersants are nonionic or anionic dispersants or mixtures of nonionic or anionic dispersants. Suitable nonionic dispersants are, in particular, ethylene oxide/propylene oxide block polymers, alkylphenol polyglycol ethers and tristryrylphenol polyglycol ethers, for example polyoxyethylene octylphenol ether, ethoxylated isooctylphenol, octylphenol, nonylphenol, alkylphenol polyglycol ether, tributylphenyl polyglycol ether, tristerylphenyl polyglycol ether, alkylaryl polyether alcohols, alcohol/ethylene oxide and fatty alcohol/ethylene oxide condensates, ethoxylated castor oil, polyoxyethylene alkyl ethers, ethoxylated polyoxypropylene, lauryl alcohol polyglycol ether acetal, sorbitol esters and methylcellulose. Suitable anionic dispersants are, in particular, alkali metal salts, alkaline earth metal salts, ammonium salts of lignosulfonic acid, naphthalenesulfonic acid, phenolsulfonic acid, dibutylnaphthalenesulfonic acid, alkylarylsulfonates, alkyl sulfates, alkyl sulfonates, fatty alcohol sulfates, fatty acids and sulfated fatty alcohol glycol ethers, furthermore arylsulfonate/formaldehyde condensates, for example condensates of sulfonated naphthalene and naphthalene derivatives of formaldehyde, condensates of naphthalene or of naphthalenesulfonic acid with phenol and formaldehyde, lignosulfonates, lignin-sulfite waste liquors, phosphated or sulfated derivatives of methylcellulose, and polyacrylic acid salts.

Antifreeze agents which can be employed are, in principle, all those substances which lower the melting point of water. The suitable antifreeze agents include alkanols such as methanol, ethanol, isopropanol, the butanols, glycol, glycerol, diethylene glycol and the like.

Thickeners which are suitable are all substances which can be employed for such purposes in agrochemical compositions, for example cellulose derivatives, polyacrylic acid derivatives, xanthan, modified clays and highly-dispersed silica.

Antifoams which can be employed are all foam-inhibitory substances which are conventional for the formulation of agrochemical active substances. Silicone antifoams and magnesium stearate are especially suitable.

Preservatives which can be used are all preservatives which may be employed for such purposes in agrochemical compositions. Examples which may be mentioned are dichlorophene, isothiazolenes such as 1,2-benzisothiazol-3(2H)-one, 2-methyl-2H-isothiazol-3-one hydrochloride, 5-chloro-2-(4-chlorobenzyl)-3(2H)-isothiazolone, 5-chloro-2-methyl-2H-isothiazol-3-one, 5-chloro-2-methyl-2H-isothiazol-3-one, 5-chloro-2-methyl-2H-isothiazol-3-one hydrochloride, 4,5-dichloro-2-cyclohexyl-4-isothiazolin-3-one, 4,5-dichloro-2-octyl-2H-isothiazol-3-one, 2-methyl-2H-isothiazol-3-one, 2-methyl-2H-isothiazol-3-one/calcium chloride complex, 2-octyl-2H-isothiazol-3-one and benzyl alcohol hemiformal.

Stickers/adhesives are added to improve the adhesion of the active ingredients to the seed after the treatment. Suitable stickers are surface-active block copolymers based on EO/PO, but also polyvinyl alcohols, polyvinylpyrrolidones, polyacrylates, polymethacrylates, polybutenes, polyisobutenes, polystyrene, polyethylenamines, polyethylenamides, polyethylenimines (Lupasol®, Polymin®), polyethers and copolymers which are derived from these polymers.

An example of a gelling agent is carrageen.

Methods which can be employed for treating the seed are, in principle, all customary methods of treating or dressing seed, such as, for example, as a dry seed treatment, as a solution for seed treatment, a water-soluble powder for seed treatment, a water-dispersible powder for the slurry treatment of seed, or by encrusting. Specifically, a procedure is followed in the treatment in which the seed is mixed, in a suitable device, for example a mixing device for solid or solid/liquid mixing partners, with the desired amount of seed treatment formulations, either as such or after previous dilution with water, until the composition is distributed uniformly on the seed. If appropriate, this is followed by a drying step.

Suitable formulations for the treatment of plants, especially the aerial part of the plants, comprise spray applications, dusts and microgranules, with spray applications being preferred.

Suitable formulations for the preparation of spray solutions to be applied undiluted are:

water-soluble concentrates (LS)
II dispersible concentrates (DC)
III emulsifiable concentrates (EC)
IV emulsions (EW, EO)
V suspensions (SC)
VI water-dispersible granules and water-soluble granules (WG)
VII water-dispersible powders and water-soluble powders (WP, SP)

Suitable formulations for the treatment of the soil are, for example, granules and spray applications.

The total application rates (i.e. the total amount of the active substances employed in accordance with the invention) for the treatment of the aerial part of the plant are preferably 0.001 to 3 kg/ha, especially preferably 0.005 to 2 kg/ha, more preferably 0.01 to 2 kg/ha and in particular 0.01 to 1 kg/ha per season.

The total application rates (i.e. the total amount of the active substances employed in accordance with the invention) for the treatment of seed are, for example, 0.1 to 1000 g, especially preferably 1 to 750 g, more preferably 5 to 200 g, even more preferably 10 to 150 g and in particular 20 to 150 g per 100 kg of seed.

The active substances employed in accordance with the invention can be formulated jointly or separately.

The use according to the invention, or the method according to the invention, result in a markedly reduced phytotoxic effect of the fungicide employed combined with an essentially unaltered or even improved fungicidal and/or insecticidal activity.

The present invention furthermore relates to a composition (composition A), comprising at least one insecticide which is selected among GABA antagonists, at least one azole fungicide and, if appropriate, at least one gibberellin.

Preferably, the composition A according to the invention comprises at least one insecticide which is selected among GABA antagonists, at least one azole fungicide and at least one gibberellin.

The at least one GABA antagonist is preferably selected among acetoprole, endosulfan, ethiprole, fipronil, vaniliprole, pyrafluprole, pyriprole and the phenylpyrazole compound of the formula Γ¹.

The present invention furthermore relates to a composition (composition B), comprising at least one insecticide which is selected among GABA antagonists, at least one strobilurin fungicide and, if appropriate, at least one gibberellin.

Preferably, the composition B according to the invention comprises at least one insecticide which is selected among GABA antagonists, at least one strobilurin fungicide and at least one gibberellin.

The invention furthermore relates to a composition (composition C), comprising at least one insecticide which is selected among nicotin receptor agonists/antagonists, at least one azole fungicide and, if appropriate, at least one gibberellin.

Preferably, the composition C according to the invention comprises at least one insecticide which is selected among nicotin receptor agonists/antagonists, at least one azole fungicide and at least one gibberellin.

The invention furthermore relates to a composition (composition D), comprising at least one insecticide which is selected among nicotin receptor agonists/antagonists, at least one strobilurin fungicide and, if appropriate, at least one gibberellin.

Preferably, the composition D according to the invention comprises at least one insecticide which is selected among nicotin receptor agonists/antagonists, at least one strobilurin fungicide and at least one gibberellin.

Preferably, the at least one azole fungicide which is present in compositions A and C is selected among difenoconazole, epoxiconazole, fluquinconazole, flutriafol, imazalil, metconazole, prochloraz, propiconazole, prothioconazole, tebuconazole, triadimenol and triticonazole, especially preferably among epoxiconazole, fluquinconazole, prochloraz and triticonazole and in particular among prochloraz and triticonazole. Specifically, it is triticonazole.

The at least one nicotin receptor agonist/antagonist is preferably selected among acetamiprid, clothianidin, dinotefuran, imidacloprid, nitenpyram, thiacloprid and thiamethoxam. It is especially preferably selected among clothianidin, imidacloprid and thiamethoxam. In particular, it is clothianidin.

The at least one gibberellin which is optionally present in the compositions A, B, C and D is preferably selected among gibberellins of the formula I. It is especially preferably gibberellic acid.

In an especially preferred embodiment of the invention, composition C according to the invention comprises clothianidin, difenoconazole and gibberellic acid.

In an alternative, especially preferred embodiment of the invention, composition C according to the invention comprises clothianidin, epoxiconazole and gibberellic acid.

In an alternative, especially preferred embodiment of the invention, composition C according to the invention comprises clothianidin, fluquinconazole and gibberellic acid.

In an alternative, especially preferred embodiment of the invention, composition C according to the invention comprises clothianidin, flutriafol and gibberellic acid.

In an alternative, especially preferred embodiment of the invention, composition C according to the invention comprises clothianidin, imazalil and gibberellic acid.

In an alternative, especially preferred embodiment of the invention, composition C according to the invention comprises clothianidin, metconazole and gibberellic acid.

In an alternative, especially preferred embodiment of the invention, composition C according to the invention comprises clothianidin, prochloraz and gibberellic acid.

In an alternative, especially preferred embodiment of the invention, composition C according to the invention comprises clothianidin, propiconazole and gibberellic acid.

In an alternative, especially preferred embodiment of the invention, composition C according to the invention comprises clothianidin, prothioconazole and gibberellic acid.

In an alternative, especially preferred embodiment of the invention, composition C according to the invention comprises clothianidin, tebuconazole and gibberellic acid.

In an alternative, especially preferred embodiment of the invention, composition C according to the invention comprises clothianidin, triadimenol and gibberellic acid.

In an alternative, especially preferred embodiment of the invention, composition C according to the invention comprises clothianidin, triticonazole and gibberellic acid.

In an alternative, especially preferred embodiment of the invention, composition C according to the invention comprises imidacloprid, difenoconazole and gibberellic acid.

In an alternative, especially preferred embodiment of the invention, composition C according to the invention comprises imidacloprid, epoxiconazole and gibberellic acid.

In an alternative, especially preferred embodiment of the invention, composition C according to the invention comprises imidacloprid, fluquinconazole and gibberellic acid.

In an alternative, especially preferred embodiment of the invention, composition C according to the invention comprises imidacloprid, flutriafol and gibberellic acid.

In an alternative, especially preferred embodiment of the invention, composition C according to the invention comprises imidacloprid, imazalil and gibberellic acid.

In an alternative, especially preferred embodiment of the invention, composition C according to the invention comprises imidacloprid, metconazole and gibberellic acid.

In an alternative, especially preferred embodiment of the invention, composition C according to the invention comprises imidacloprid, prochloraz and gibberellic acid.

In an alternative, especially preferred embodiment of the invention, composition C according to the invention comprises imidacloprid, propiconazole and gibberellic acid.

In an alternative, especially preferred embodiment of the invention, composition C according to the invention comprises imidacloprid, prothioconazole and gibberellic acid.

In an alternative, especially preferred embodiment of the invention, composition C according to the invention comprises imidacloprid, tebuconazole and gibberellic acid.

In an alternative, especially preferred embodiment of the invention, composition C according to the invention comprises imidacloprid, triadimenol and gibberellic acid.

In an alternative, especially preferred embodiment of the invention, composition C according to the invention comprises imidacloprid, triticonazole and gibberellic acid.

In an alternative, especially preferred embodiment of the invention, composition A according to the invention comprises fipronil, difenoconazole and gibberellic acid.

In an alternative, especially preferred embodiment of the invention, composition A according to the invention comprises fipronil, epoxiconazole and gibberellic acid.

In an alternative, especially preferred embodiment of the invention, composition A according to the invention comprises fipronil, fluquinconazole and gibberellic acid.

In an alternative, especially preferred embodiment of the invention, composition A according to the invention comprises fipronil, flutriafol and gibberellic acid.

In an alternative, especially preferred embodiment of the invention, composition A according to the invention comprises fipronil, imazalil and gibberellic acid.

In an alternative, especially preferred embodiment of the invention, composition A according to the invention comprises fipronil, metconazole and gibberellic acid.

In an alternative, especially preferred embodiment of the invention, composition A according to the invention comprises fipronil, prochloraz and gibberellic acid.

In an alternative, especially preferred embodiment of the invention, composition A according to the invention comprises fipronil, propiconazole and gibberellic acid.

In an alternative, especially preferred embodiment of the invention, composition A according to the invention comprises fipronil, prothioconazole and gibberellic acid.

In an alternative, especially preferred embodiment of the invention, composition A according to the invention comprises fipronil, tebuconazole and gibberellic acid.

In an alternative, especially preferred embodiment of the invention, composition A according to the invention comprises fipronil, triadimenol and gibberellic acid.

In an alternative, especially preferred embodiment of the invention, composition A according to the invention comprises fipronil, triticonazole and gibberellic acid.

In an alternative, especially preferred embodiment of the invention, composition D according to the invention comprises clothianidin and azoxystrobin.

In an alternative, especially preferred embodiment of the invention, composition D according to the invention comprises clothianidin and dimoxystrobin.

In an alternative, especially preferred embodiment of the invention, composition D according to the invention comprises clothianidin and orysastrobin.

In an alternative, especially preferred embodiment of the invention, composition D according to the invention comprises clothianidin, azoxystrobin and gibberellic acid.

In an alternative, especially preferred embodiment of the invention, composition D according to the invention comprises clothianidin, dimoxystrobin and gibberellic acid.

In an alternative, especially preferred embodiment of the invention, composition D according to the invention comprises clothianidin, orysastrobin and gibberellic acid.

In an alternative, especially preferred embodiment of the invention, composition D according to the invention comprises imidacloprid and azoxystrobin.

In an alternative, especially preferred embodiment of the invention, composition D according to the invention comprises imidacloprid and dimoxystrobin.

In an alternative, especially preferred embodiment of the invention, composition D according to the invention comprises imidacloprid and orysastrobin.

In an alternative, especially preferred embodiment of the invention, composition D according to the invention comprises imidacloprid, azoxystrobin and gibberellic acid.

In an alternative, especially preferred embodiment of the invention, composition D according to the invention comprises imidacloprid, dimoxystrobin and gibberellic acid.

In an alternative, especially preferred embodiment of the invention, composition D according to the invention comprises imidacloprid, orysastrobin and gibberellic acid.

In an alternative, especially preferred embodiment of the invention, composition B according to the invention comprises fipronil and azoxystrobin.

In an alternative, especially preferred embodiment of the invention, composition B according to the invention comprises fipronil and dimoxystrobin.

In an alternative, especially preferred embodiment of the invention, composition B according to the invention comprises fipronil and orysastrobin.

In an alternative, especially preferred embodiment of the invention, composition B according to the invention comprises fipronil, azoxystrobin and gibberellic acid.

In an alternative, especially preferred embodiment of the invention, composition B according to the invention comprises fipronil, dimoxystrobin and gibberellic acid.

In an alternative, especially preferred embodiment of the invention, composition B according to the invention comprises fipronil, orysastrobin and gibberellic acid.

The compositions according to the invention may take the form of a physical mixture of at least one of the above-defined fungicides with at least one of the above-defined insecticides and, if appropriate, at least one of the above-defined gibberellins. However, the composition may also be any combination of the active substances, where it is not necessary for the individual active substances to be present as a joint formulation.

An example of compositions according to the invention in which the at least one fungicide and the at least one insecticide and, if appropriate, the at least one gibberellin are not present in a joint formulation is a 2-component kit or a 3-component kit.

Accordingly, the present invention also relates to a 2-component kit, comprising a first component which comprises the at least one fungicide, a liquid or solid carrier and, if appropriate, at least one surface-active substance and/or at least one customary adjuvant, and a second component which comprises at least one insecticide, a liquid or solid carrier and, if appropriate, at least one surface-active substance and/or at least one customary adjuvant. If appropriate, the second component further comprises at least one gibberellin.

The present invention also relates to a 3-component kit, comprising a first component which comprises the at least one fungicide, a liquid or solid carrier and, if appropriate, at least one surface-active substance and/or at least one customary adjuvant, a second component which comprises at least one insecticide, a liquid or solid carrier and, if appropriate, at least one surface-active substance and/or at least one customary adjuvant, and a third component which comprises at least one gibberellin, a liquid or solid carrier and, if appropriate, at least one surface-active substance and/or at least one customary adjuvant.

Suitable liquid and solid carriers, surface-active substances and customary adjuvants are described hereinabove.

The compositions according to the invention can be present in formulated form, as described above, and/or they can contain the abovementioned, additional components (for example other active substances (fungicides, insecticides, herbicides, bactericides, nematicides, fertilizers, growth regulators and the like), adjuvants, oils, wetters and the like).

As regards the suitable and preferred weight ratios of the components present in compositions A to D, the application rates and the nature of their application, reference is made to what has been said above.

In comparison with corresponding compositions which, however, do not comprise any insecticide as defined above, nor any gibberellin, the compositions according to the invention are distinguished by a markedly reduced phytotoxicity. At the same time, their fungicidal activity is essentially unaltered or even improved. In addition, they also have an insecticidal activity, so that they are suitable both for the treatment of phytopathogenic fungi and of undesirable pests. Accordingly, the invention also relates to the use of the compositions according to the invention for the control of phytopathogenic fungi.

They are particularly suitable for controlling the following phytopathogenic fungi:
Alternaria species on vegetables, oilseed rape, sugar beet, fruit and rice, for example A. solani or A. alternata on potatoes and tomatoes,
Aphanomyces species on sugar beet and vegetables,
Bipolaris and Drechslera species on maize, cereals, rice and turf, for example D. maydis on maize, Blumeria graminis (powdery mildew) on cereals,
Botrytis cinerea (gray mold) on strawberries, vegetables, flowers and grape vines,
Bremia lactucae on lettuce,
Cercospora species on maize, soybeans, rice and sugar beet,
Cochliobolus species on maize, cereals, rice (for example Cochliobolus sativus on cereals, Cochliobolus miyabeanus on rice),
Colletotricum species on soybeans and cotton,
Drechslera species and Pyrenophora species on cereals, rice, turf and maize, for example D. teres on barley or D. tritici-repentis on wheat,
Esca on grape vines, caused by Phaeoacremonium chlamydosporium, Ph. Aleophilum, and Formitipora punctata (syn. Phellinus punctatus),
Exserohilum species on maize,
Erysiphe cichoracearum and Sphaerotheca fuliginea on cucurbits,
Fusarium and Verticillium species on various plants, for example F. graminearum or F. culmorum on cereals or F. oxysporum on a multiplicity of plants such as, for example, tomatoes,
Gaeumanomyces graminis on cereals,
Gibberella species on cereals and rice (for example Gibberella fujikuroi on rice),
Grainstaining complex on rice,
Helminthosporium species on maize and rice,
Michrodochium nivale on cereals,
Mycosphaerella species on cereals, bananas and peanuts, for example M. graminicola on wheat or M. fijiensis on bananas,
Peronospora species on cabbage and bulb plants, such as, for example, P. brassicae on cabbage or P. destructor on onions,
Phakopsora pachyrhizi and Phakopsora meibomiae on soybeans,
Phomopsis species on soybeans and sunflowers,
Phytophthora infestans on potatoes and tomatoes,
Phytophthora species on a variety of plants such as, for example, P. capsici on capsicum,
Plasmopara viticola on grape vines,
Podosphaera leucotricha on apples,
Pseudocercosporella herpotrichoides on cereals,
Pseudoperonospora species on a variety of plants such as, for example, P. cubensis on cucumbers or P. humili on hops,
Puccinia species on a variety of plants such as, for example, P. triticina, P. striformins, P. hordei or P. graminis on cereals, or P. asparagi on asparagus,
Pyrenophora species on cereals,
Pyricularia oryzae, Corticium sasakii, Sarocladium oryzae, S. attenuatum, Entyloma oryzae on rice,
Pyricularia grisea on turf and cereals,
Pythium spp. on turf, rice, maize, cotton, oilseed rape, sunflowers, sugar beet, vegetables and other plants, for example P. ultiumum on a variety of plants, P. aphanidermatum on turf,
Rhizoctonia species on cotton, rice, turf, maize, oilseed rape, potatoes, sugar beet, vegetables and other plants, for example R. solani on beet and a variety of plants,
Rhynchosporium secallis on barley, rye and triticale,
Sclerotinia species on oilseed rape and sunflowers,
Septoria tritici and Stagonospora nodorum on wheat,
Erysiphe (syn. Uncinula) necator on grape vines,
Setospaeria species on maize and turf,
Sphacelotheca reilinia on maize,
Thievaliopsis species on soybeans and cotton,
Tilletia species on cereals,
Ustilago species on cereals, maize and sugar beet, for example U. maydis on maize, and
Venturia species (scab) on apples and pears, for example V. inaequalis on apples.

In particular, the compositions according to the invention are suitable for controlling soybean rust (Phakopsora pachyrhizi and Phakopsora meibomiae).

The present invention also relates to the use of the compositions according to the invention for controlling pests, in particular insects and/or arachnids.

The following pests can be controlled efficiently by the compositions according to the invention:
Lepidoptera: for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutolla xylostella, Pseudoplusia includens, Rhyacionia frustrana, Scrobipalpula absoluta, Sitotroga cerealella, Sparganothis pilleriana, Spodoptera eridania, Spodoptera frugiperda, Spodoptera littoralis, Spodoptera litura, Thaumatopoea pityocampa, Tortrix viridana, Trichoplusia ni and Zeiraphera canadensis,
Coleoptera (beetles), for example Agrilus sinuatus, Agriotes lineatus, Agriotes obscurus, Amphimallus solstitialis, Anisandrus dispar, Anthonomus grandis, Anthonomus pomorum, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcate, Ceuthorrhynchus assimilis, Ceuthorrhynchus napi, Chaetocnema tibialis, Conoderus vespertinus, Crioceris asparagi, Diabrotica longicornis, Diabrotica 12-punctata, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllotreta chrysocephala, Phyllophaga sp., Phyllopertha horticola, Phyllotreta nemorum, Phyllotreta striolata, Popillia japonica, Sitona lineatus and Sitophilus granaria,
Diptera, for example Aedes aegypti, Aedes vexans, Anastrepha ludens, Anopheles maculipennis, Ceratitis capitata, Chrysomya bezziana, Chrysomya hominivorax, Chrysomya macellaria, Contarinia sorghicola, Cordylobia anthropophaga, Culex pipiens, Dacus cucurbitae, Dacus oleae, Dasineura brassicae, Fannia canicularis, Gasterophilus intestinalis, Glossina morsitans, Haematobia irritans, Haplodiplosis equestris, Hylemyia platura, Hypoderma lineata, Liriomyza sativae, Liriomyza trifolii, Lucilia caprina, Lucilia cuprina, Lucilia sericata, Lycoria pectoralis, Mayetiola destructor, Musca domestica, Muscina stabulans, Oestrus ovis, Oscinella frit, Pegomya hysocyami, Phorbia antiqua, Phorbia brassicae, Phorbia coarctata, Rhagoletis cerasi, Rhagoletis pomonella, Tabanus bovinus, Tipula oleracea and Tipula paludosa,
Thysanoptera (thrips), for example Dichromothrips spp., Frankliniella fusca, Frankliniella occidentalis, Frankliniella tritici, Scirtothrips citri, Thrips oryzae, Thrips palmi and Thrips tabaci,
Hymenoptera for example Athalia rosae, Atta cephalotes, Atta sexdens, Atta texana, Hoplocampa minuta, Hoplocampa testudinea, Monomorium pharaonis, Solenopsis geminata and Solenopsis invicta,
Heteroptera, for example Acrostemum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis and Thyanta perditor,
Homoptera (especially aphids), for example Acyrthosiphon onobrychis, Adelges laricis, Aphidula nasturtii, Aphis craccivora, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Bemisa tabaci, Bemisa argentifolii, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthurn pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminurn, Schizoneura lanuginosa, Sitobion avenae, Trialeurodes vaporariorum, Toxoptera aurantiiand, and Viteus vitifolii,
Isoptera(termites), for example Calotermes flavicollis, Leucotermes flavipes, Reticulitermes lucifugus and Termes natalensis,
Orthoptera, for example Acheta domestica, Blatta orientalis, Blattella germanica, Forficula auricularia, Gryllotalpa gryllotalpa, Locusta migratoria, Melanoplus bivittatus, Melanoplus femur-rubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus,
Collembola (springtails), for example Onychiurus ssp., and
Arachnids (Arachnoidea) such as mites (Acarina), for example of the families Argasidae, Ixodidae and Sarcoptidae, such as Amblyomma americanum, Amblyomma variegatum, Argas persicus, Boophilus annulatus, Boophilus decoloratus, Boophilus microplus, Dermacentor silvarum, Hyalomma truncatum, Ixodes ricinus, Ixodes rubicundus, Ornithodorus moubata, Otobius megnini, Dermanyssus gallinae, Psoroptes ovis, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus pacificus, Tetranychus telarius and Tetranychus urticae, Panonychus ulmi, Panonychus citri, and oligonychus pratensis.

The compositions according to the invention can also be employed successfully for controlling nematodes.

The invention will now be illustrated by the following, nonlimiting examples.

### EXAMPLES

### 1. Emergence Behavior of Soybeans

The emergence behavior of soybeans whose seeds have been treated with triticonazole or with a combination of triticonazole and fipronil was studied. For this purpose, seeds of the variety “Conquista” were treated with triticonazole (employed as FS formulation in a concentration of 200 g/l; 25 g or 50 g active substance per 100 kg seed) or with triticonazole in the abovementioned formulation and amount and subsequently immediately with fipronil (applied as FS formulation in a concentration of 250 g/l; 50 g active substance per 100 kg seed) by means of the HEGE11 seed treatment apparatus. The seeds were sown on the very same day. After seven days, the number of seeds which had given rise to plants was examined. The results are shown in the table which follows. A value of 100% means that all sown seeds have given rise to plants.

TABLE 1

| Treatment | Emergence [%] |
|---|---|
| — | 97 |
| Triticonazole [25 g a.s. per 100 kg seeds] | 77 |
| Triticonazole [50 g a.s. per 100 kg seeds] | 65 |
| Triticonazole [25 g a.s. per 100 kg seeds] + | 84 |
| Fipronil [50 g a.s. per 100 kg seeds] | |
| Triticonazole [50 g a.s. per 100 kg seeds] + | 77 |
| Fipronil [50 g a.s. per 100 kg seeds] | |

a.s. = active substance

### 2. Vitality of the Plants 14 Days after Sowing

Seeds of the variety “Conquista” were treated either with tritconazole alone (50 g active substance per 100 kg seeds) or with a combination of triticonazole and fipronil (fipronil: 50 g active substance per 100 kg seeds) or triticonazole in combination with fipronil and gibberellic acid (gibberellic acid employed as 90% active substance concentrate in a mixture of water and acetone; 1 g active substance per 100 kg seeds) as described above and subsequently sown. 14 days after sowing, the vitality of the plants was examined visually. The results are shown in the table which follows. The vitality is determined by visually comparing plants from untreated seeds and plants from treated seeds. The criteria used were the abovementioned criteria (a) to (q), mainly the toughness of the plant, the color intensity of the leaves, the size of the leaves (leaf area), the size of the plant, the plant density, the length of the stalk, any necroses and the visual overall appearance of the plant, and assessed using a scale of from 0 to 10. Plants from untreated seeds are given the value 5. An improvement by 20% of the average overall appearance of the plants in comparison with plants from untreated seeds means a value of 6, an improvement by 40% a value of 7 and the like, while a deterioration in comparison with plants from untreated seeds by 20% means a value of 4, a deterioration by 40% a value of 3, and the like.

TABLE 2

| Treatment | Vitality |
|---|---|
| — | 5 |
| Triticonazole [50 g a.s. per 100 kg seeds] | 2 |
| Triticonazole [50 g a.s. per 100 kg seeds] + | 4 |
| Fipronil [50 g a.s. per 100 kg seeds] | |
| Triticonazole [50 g a.s. per 100 kg seeds] + | 5 |
| Fipronil [50 g a.s. per 100 kg seeds] + | |
| Gibberellic acid [1 g a.s. per 100 kg seeds] | |

a.s. = active substance

### 3. Linear Stand 14 Days after Sowing

The linear stand indicates the number of plants per meter and is a measure for the number of plants which will survive for some time after emergence. Seeds of the variety “Conquista” were treated as in example 1. 14 days after sowing, the number of plants per meter was counted and averaged. The results are shown in the table which follows.

TABLE 3

| Treatment | Linear stand [plants/m] |
|---|---|
| — | 21 |
| Triticonazole [25 g a.s. per 100 kg seeds] | 15 |
| Triticonazole [50 g a.s. per 100 kg seeds] | 13 |
| Triticonazole [25 g a.s. per 100 kg seeds] + | 17 |
| Fipronil [50 g a.s. per 100 kg seeds] | |
| Triticonazole [50 g a.s. per 100 kg seeds] + | 15 |
| Fipronil [50 g a.s. per 100 kg seeds] | |

a.s. = active substance

### 4. Fungicidal Activity Against Soybean Rust

The experiments which follow demonstrate that the use of triticonazole in combination with fipronil or with fipronil and gibberellic acid leads to no substantial deterioration and in some cases even to an improvement of the fungicidal activity of triticonazole. Seeds of the variety “Conquista” were treated as in example 2. After the plants' emergence, they were inoculated four times at 7-day intervals in each case with spores of Phakopsora pachyrhizi (5×10⁵ spores per ml). 21 and 35 days after sowing, the infection level was assessed visually. The visually determined values for the percentage of diseased leaf areas are shown in the tables which follow.

TABLE 4
Infection level in the lower part of the plant 21 days after sowing

| Treatment | Infection [%] |
|---|---|
| — | 8.5 |
| Triticonazole [50 g a.s. per 100 kg seeds] | 0 |
| Triticonazole [50 g a.s. per 100 kg seeds] + | 0 |
| Fipronil [50 g a.s. per 100 kg seeds] | |
| Triticonazole [50 g a.s. per 100 kg seeds] + | 0.1 |
| Fipronil [50 g a.s. per 100 kg seeds] + | |
| Gibberellic acid [1 g a.s. per 100 kg seeds] | |

a.s. = active substance

TABLE 5
Infection level in the lower part of the plant 35 days after sowing

| Treatment | Infection [%] |
|---|---|
| — | 70 |
| Triticonazole [50 g a.s. per 100 kg seeds] | 47 |
| Triticonazole [50 g a.s. per 100 kg seeds] + | 43 |
| Fipronil [50 g a.s. per 100 kg seeds] | |
| Triticonazole [50 g a.s. per 100 kg seeds] + | 43 |
| Fipronil [50 g a.s. per 100 kg seeds] + | |
| Gibberellic acid [1 g a.s. per 100 kg seeds] | |

a.s. = active substance

TABLE 6
Infection level of the leaves in the middle
part of the plant 35 days after sowing

| Treatment | Infection [%] |
|---|---|
| — | 10.5 |
| Triticonazole [50 g a.s. per 100 kg seeds] | 9 |
| Triticonazole [50 g a.s. per 100 kg seeds] + | 8.5 |
| Fipronil [50 g a.s. per 100 kg seeds] | |
| Triticonazole [50 g a.s. per 100 kg seeds] + | 7 |
| Fipronil [50 g a.s. per 100 kg seeds] + | |
| Gibberellic acid [1 g a.s. per 100 kg seeds] | |

a.s. = active substance

### 5. Emergence Behavior in Wheat

The emergence behavior of wheat plants whose seeds had been treated with triticonazole and prochloraz or with a combination of triticonazole, prochloraz and fipronil, was studied. To this end, wheat seeds were treated with triticonazole (5 g of active substance per 100 kg of seeds) and prochloraz (12 g of active substance per 100 kg of seeds, or with triticonazole and prochloraz in each case in the abovementioned amount and then immediately with fipronil (50 g of active substance per 100 kg of seeds) using a HEGE11 seed treatment apparatus. On the very same day, the seeds were sown. After 71 days, the number of seeds which had given rise to plants was determined. The results are shown in the table which follows. A value of 100% means that all of the sown seeds had given rise to plants.

TABLE 7

| Treatment | Emergence [%] |
|---|---|
| — | 84 |
| Triticonazole [5 g a.s. per 100 kg of seeds] + | 31 |
| Prochloraz [12 g a.s. per 100 kg of seeds] | |
| Triticonazole [5 g a.s. per 100 kg of seeds] + | 55 |
| Prochloraz [12 g a.s. per 100 kg of seeds] + | |
| Fipronil [50 g a.s. per 100 kg of of seeds] | |

a.s. = active substance

1. The use of insecticides which are selected among GABA antagonists and nicotin receptor agonists/antagonists, if appropriate in combination with at least one gibberellin, as safener for fungicides which have a phytotoxic effect on plants treated therewith, seeds treated therewith or on plants which grow in a substrate treated therewith.

2. The use according to claim 1, where the GABA antagonists are selected among acetoprole, endosulfan, ethiprole, fipronil, vaniliprole, pyrafluprole, pyriprole and the phenylpyrazole compound of the formula Γ¹

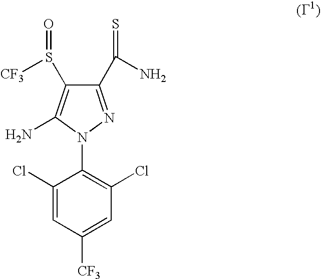

3. The use according to claim 2, where the GABA antagonist is fipronil.

4. The use according to claim 1, where the nicotin receptor agonists/antagonists are selected among acetamiprid, clothianidin, dinotefuran, imidacloprid, nitenpyram, thiacloprid and thiamethoxam.

5. The use according to claim 4, where the nicotin receptor agonists/antagonists are selected among acetamiprid, clothianidin, imidacloprid and thiamethoxam.

6. The use according to claim 1, where the gibberellins are selected among gibberellin A₁, gibberellin A₃, gibberellin A₄ and gibberellin A₇.

7. The use according to claim 6, where the gibberellin is gibberellin A₃.

8. The use according to claim 1, where the fungicides are selected among azole fungicides.

9. The use according to claim 8, where the azole fungicides are selected among difenoconazole, epoxiconazole, fluquinconazole, flutriafol, imazalil, metconazole, prochloraz, propiconazole, prothioconazole, tebuconazole, triadimenol and triticonazole.

10. The use according to claim 9, where the azole fungicides are selected among epoxiconazole, fluquinconazole, prochloraz and triticonazole.

11. The use according to claim 10, where the azole fungicides are selected among prochloraz and triticonazole.

12. The use according to claim 11, where the azole fungicide is triticonazole.

13. The use according to claim 1, where the fungicides are selected among strobilurin fungicides.

14. The use according to claim 13, where the strobilurin fungicides are selected among azoxystrobin, dimoxystrobin and orysastrobin.

15. The use according to claim 1, for improving the germination and/or the emergence and/or the vitality of plants which, or whose seeds or whose growth substrate, have been or are treated with a fungicide as defined in claim 1.

16. The use according to claim 15 for improving the germination and/or the emergence and/or the vitality of plants whose seeds have been treated with a fungicide as defined in claim 1.

17. A method of reducing or preventing the phytotoxic effect of fungicides as defined in claim 1 on plants which, or whose seeds or whose growth substrate, have been or are treated with these fungicides, where the plant and/or its seeds and/or its growth substrate is treated with at least one fungicide as defined in claim 1 in combination with at least one insecticide as defined claim 1 and, if appropriate, with at least one gibberellin as defined in claim 1.

18. The method according to claim 17 for reducing or preventing the phytotoxic effect of fungicides as defined in claim 1 on plants whose seeds have been treated with these fungicides, where the seeds of the plants are treated with at least one fungicide as defined in claim 1 in combination with at least one insecticide as defined in claim 1 and, if appropriate, with at least one gibberellin as defined in claim 1.

19. The method according to claim 17, for improving the germination and/or the emergence and/or the vitality of plants.

20. The use or method according to claim 1, where the plants are selected among soybean, maize, wheat, triticale, rye, oats, barley, oilseed rape, millet/sorghum, rice, sunflower, cotton, sugar beet, stone fruit, pome fruit, citrus fruit, banana, strawberry, blueberry, almond, grape, mango, pawpaw, peanut, potato, tomato, capsicum, cucumber, pumpkin/squash, melon, watermelon, garlic, onion, carrot, cabbage, bean, vegetable pea and fodder pea, lentil, lucerne, clover, flax, elephant grass, grass, lettuce, sugar cane, tea, tobacco and coffee.

21. The use or method according to claim 20, where the plants are selected among soybean, oilseed rape, maize and wheat.

22. The use or method according to claim 21, where the plants are selected among soybean and wheat.

23. The use or method according to claim 22, where the plants are transgenic or nontransgenic soybean.

24. A composition comprising at least one GABA antagonist, at least one azole fungicide and, if appropriate, at least one gibberellin.

25. A composition comprising at least one GABA antagonist, at least one azole fungicide and at least one gibberellin.

26. A composition comprising at least one GABA antagonist, at least one strobilurin fungicide and, if appropriate, at least one gibberellin.

27. A composition comprising at least one GABA antagonist, at least one strobilurin fungicide and at least one gibberellin.

28. A composition comprising at least one nicotin receptor agonist/antagonist, at least one azole fungicide and, if appropriate, at least one gibberellin.

29. A composition comprising at least one nicotin receptor agonist/antagonist, at least one azole fungicide and at least one gibberellin.

30. A composition comprising at least one nicotin receptor agonist/antagonist, at least one strobilurin fungicide and, if appropriate, at least one gibberellin.

31. A composition comprising at least one nicotin receptor agonist/antagonist, at least one strobilurin fungicide and at least one gibberellin.

32. A composition according to claim 24, where the at least one azole fungicide is selected among difenoconazole, epoxiconazole, fluquinconazole, flutriafol, imazalil, metconazole, prochloraz, propiconazole, prothioconazole, tebuconazole, triadimenol and triticonazole.

33. The composition according to claim 32, where the at least one azole fungicide is selected among epoxiconazole, fluquinconazole, prochloraz and triticonazole.

34. The composition according to claim 28, where the at least one nicotin receptor agonist/antagonist is selected among acetamiprid, clothianidin, dinotefuran, imidacloprid, nitenpyram, thiacloprid and thiamethoxam.
